(19) United States
(12) Patent Application Publication
(10) Pub. No.: US 2026/0087053 A1
(43) Pub. Date: Mar. 26, 2026

(54) SYSTEMS AND METHODS FOR GENERATING GENERATIVE ARTIFICIAL INTELLIGENCE RESPONSES USING CONTEXT BASED HIERARCHICAL ONTOLOGICAL REPRESENTATIONS

(71) Applicant: Accenture Global Solutions Limited, Dublin (IE)

(72) Inventors: Wei WEI, Burlingame, CA (US); Yuja BAO, Cambridge, MA (US); Alireza REZAZADEH, Mountain View, CA (US); Zichao LI, Mountain View, CA (US)

(73) Assignee: Accenture Global Solutions Limited, Dublin (IE)

(21) Appl. No.: 19/336,019

(22) Filed: Sep. 22, 2025

Related U.S. Application Data
(60) Provisional application No. 63/697,856, filed on Sep. 23, 2024.

(51) Int. Cl. G06F 16/334; G06F 16/36; G06N 5/02

(52) U.S. Cl. CPC G06F 16/3347; G06F 16/367; G06N 5/02

(57) ABSTRACT

Systems and methods for generating Generative Artificial Intelligence (Gen AI) responses using context based hierarchical ontological representations are disclosed. In an aspect, input prompt data corresponding to an enterprise is received. A query embedding vector representing the received input prompt data is then generated. Further, at least one relevant node corresponding to the input prompt data is generated. Furthermore, a subset of nodes are selected based on the relevant node. Also, contextual data is generated by aggregating textual content from the selected subset of nodes. An ontological representation corresponding to the input prompt data is generated based on the generated contextual data. A Gen AI response to the input prompt data is then generated using at least one Gen AI model. The generated Gen AI response is then validated. Also, the Gen AI model and the ontological representation are fine-tuned based on results of the validation.

### CROSS-REFERENCE TO RELATED APPLICATION(S)

This application claims priority under 35 USC § 119 (c) to a U.S. Provisional Application No. 63/697,856, filed on Sep. 23, 2024, the entire content of which is hereby incorporated by reference in the entirety for all purposes.

### TECHNICAL FIELD

Various examples described herein relate generally to a method and system for generating Generative Artificial Intelligence (Gen AI) responses. Specifically, the disclosed examples are directed to techniques for generating the Gen AI responses using context based hierarchical ontological representations.

### BACKGROUND

Conventional large language models (LLMs) have been developed with increasingly large context windows, enabling the processing of longer input sequences during inference. While the large context windows allow for broader access to recent information, existing LLM architectures remain inherently limited in their ability to perform reasoning over long-term memory. These limitations arise from the reliance on fixed-size transformer architectures and key-value caching mechanisms. The key-value caching mechanisms are designed to support short-term attention across a finite window of tokens, but the mechanisms lack the architectural flexibility needed to aggregate and integrate knowledge from large volumes of historical data. As a result, the LLMs struggle to retain and utilize relevant information from earlier interactions or prior experiences, especially when the information spans multiple contexts or is distributed across different memory entries.

To improve long-term information retention in the LLMs, various existing approaches have explored the use of external memory systems that supplement native transformer context. The systems often store past data as independent entries and retrieve relevant content through similarity-based search in an embedding space. While the existing approaches enable retrieval beyond the immediate context window, the existing approaches typically lack mechanisms for modeling relationships between memory entries. As a result, stored experiences remain isolated, limiting the system's ability to draw connections or build higher-level abstractions. This lack of structural organization becomes increasingly problematic as the volume of stored information grows or when relevant knowledge is dispersed across multiple memory entries.

### SUMMARY

Implementations of the present disclosure are generally directed to systems and methods generating Generative Artificial Intelligence (Gen AI) responses. Specifically, the disclosed examples are directed to techniques for generating the Gen AI responses using context based hierarchical ontological representations.

In some examples, aspects of the subject matter described herein provide a system including a processor and a memory communicably coupled to the processor, wherein the memory comprises processor-executable instructions which, when executed by the processor, cause the processor to receive input prompt data corresponding to an enterprise from at least one data source, wherein the input prompt data comprises a user query and user requirements. Further, the processor is configured to generate a query embedding vector representing the received input prompt data using an embedding model, wherein the query embedding vector comprises a numerical representation of the input prompt data indicating a semantic meaning corresponding to the input prompt data. Furthermore, the processor is configured to retrieve at least one relevant node corresponding to the input prompt data from a pre-determined ontological representation by calculating cosine similarities between the generated query embedding vector and a plurality of embedding vectors of a plurality of nodes within the pre-determined ontological representation using a collapsed tree retrieval model. The processor is then configured to select a subset of nodes comprising the cosine similarities exceeding a predetermined retrieval threshold based on the retrieved at least one relevant node. In addition, the processor is configured to generate contextual data corresponding to the input prompt data by aggregating textual content from the selected subset of nodes.

Moreover, the processor is configured to generate an ontological representation corresponding to the input prompt data based on the generated contextual data, wherein the ontological representation comprises a plurality of nodes comprising the textual content and the embedding vectors derived using the embedding model. The processor is then configured to generate a Gen AI response to the input prompt data using at least one Gen AI model based on the generated contextual data and the generated ontological representation. Also, the processor is configured to validate the generated Gen AI response by comparing the Gen AI response with a reference response using at least one performance metric, wherein the at least one performance metric comprises at least one of accuracy-based measures, similarity-based measures, and quality assessment measures. Further, the processor is configured to fine-tune the at least one Gen AI model and the ontological representation based on results of the validation, wherein the fine-tuning of the ontological representation comprises updating a node content and the embedding vectors.

The present disclosure further describes a method, executed by the processor provided herein, for generating the Gen AI responses using the context based hierarchical ontological representations. The present disclosure also describes non-transitory computer-readable medium coupled to the processor and having instructions stored thereon which, when executed by the processor, cause the processor to perform operations in accordance with the method described herein.

It is appreciated that method in accordance with the present disclosure can include any combination of the aspects and features described herein. That is, the method in accordance with the present disclosure is not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 depicts an example environment that may be used to execute implementations of the present disclosure.

FIG. 2 depicts an example architecture of a Generative Artificial Intelligence (Gen AI) response generation system, in accordance with implementations of the present disclosure.

FIG. 3 depicts an example context based hierarchical ontological representation, in accordance with implementations of the present disclosure.

FIG. 4 depicts an example context based hierarchical ontological representation generated using multi-document question answering dataset, in accordance with implementations of the present disclosure.

FIG. 5 depicts an example graphs illustrating depth based statistics of the context based hierarchical ontological representation generated using the multi-document question answering dataset, in accordance with implementations of the present disclosure.

FIG. 6 depicts an example graphs illustrating effect of a depth-adaptive similarity threshold on the context based hierarchical ontological representation generated using the multi-document question answering dataset, in accordance with implementations of the present disclosure.

FIG. 7 is a flow diagram that represents an example method for generating Gen AI responses using context based hierarchical ontological representations, in accordance with implementations of the present disclosure.

FIG. 8 depicts a block diagram of an example computer system that may be used to implement the method for generating the Gen AI responses using the context based hierarchical ontological representations, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” etc., re labels to distinguish components or blocks of otherwise similar names but does not imply any sequence or numerical limitation.

“And/or” for two possibilities means either or both stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

Implementations of the present disclosure may provide systems and methods relates to Generative Artificial Intelligence (Gen AI) response generation using context based hierarchical ontological representations. The present disclosure utilizes the context based hierarchical ontological representations to enhance memory organization, retrieval, and integration. In contrast to existing approaches that rely on flat or unstructured memory (e.g., key-value lookup tables), the present disclosure introduces a dynamic and structured memory model. In an aspect, the context-based hierarchical ontological representation may include a tree-structured memory hierarchy, wherein each node represents a semantically coherent unit of information. Each node may include aggregated textual content, corresponding semantic embeddings, and metadata indicative of abstraction levels or contextual relevance. The hierarchical nature of the representation enables progressive abstraction across tree depths, thereby allowing efficient reasoning at multiple semantic levels.

Further, implementations of the present disclosure dynamically updates a memory structure by computing semantic embeddings of newly processed information and comparing the semantic embeddings with embeddings of existing nodes. Based on similarity metrics, new information is integrated into appropriate locations within the hierarchy, either by enriching existing nodes or by generating new branches. This adaptive mechanism improves the system's context sensitivity and allows for more accurate and efficient retrieval of relevant information during inference or generation. Also, the context based hierarchical ontological representations may enable the system to support extended user interactions and complex reasoning tasks more effectively than the existing approaches.

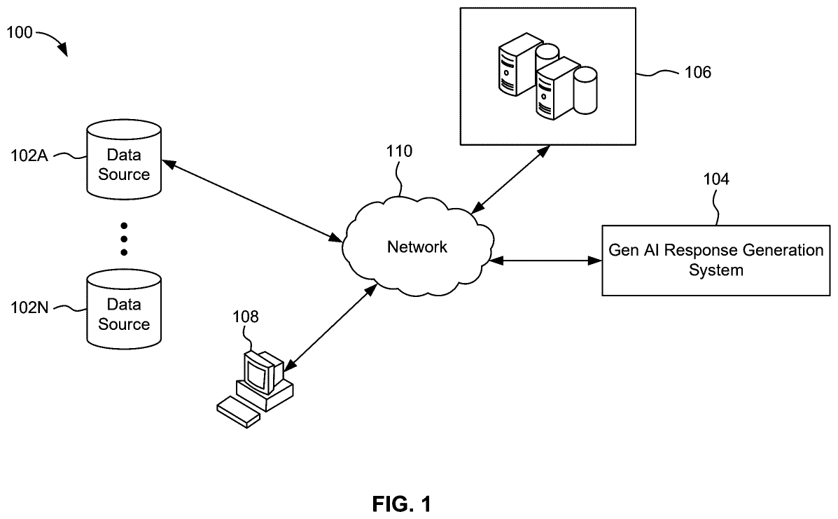

FIG. 1 depicts an example environment 100 that may be used to execute implementations of the present disclosure. The example environment 100, shown in FIG. 1, includes data sources 102A-N, a Gen AI response generation system 104, a storage device 106 and a user device 108. For simplicity, a single user device 108 is depicted in FIG. 1, however it should be noted that the example environment 100 may include one or more user devices. The data sources 102A-N, the Gen AI response generation system 104, the storage device 106 and the user device 108 may communicate with each other using a network 110. In some examples, the network 110 may include a Local Area Network (LAN), a Wide Area Network (WAN), the Internet, or a combination thereof. In some examples, the network 110 may be accessed over a wired and/or a wireless communication link.

The plurality of data sources 102A-N may include communication devices and/or computing devices that includes information corresponding to an enterprise. The plurality of data sources 102A-N may include a server such as a web server, a database server, a host server, a proxy server, a virtual server (e.g., executing on a computing hardware), or a server in a cloud computing system.

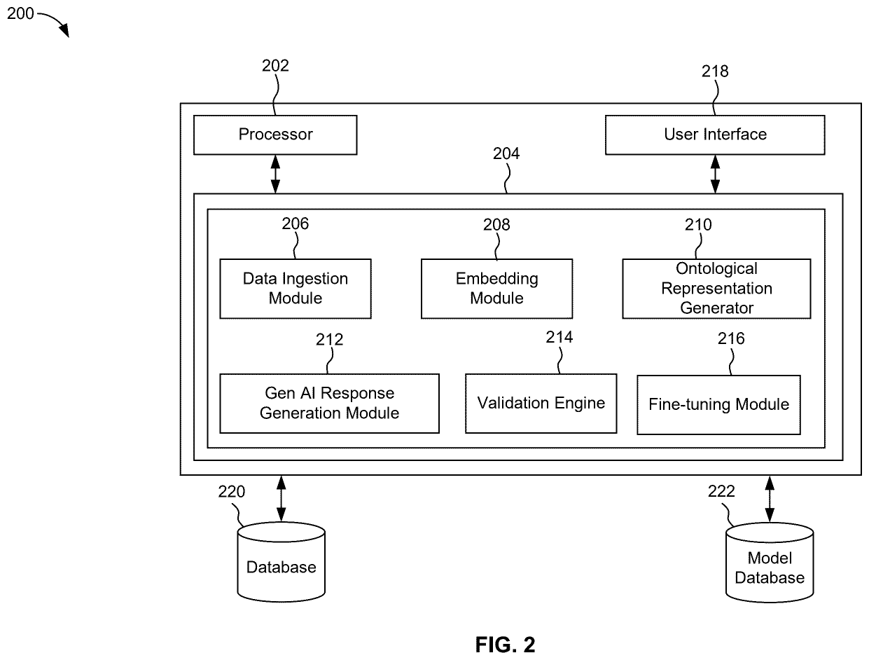

The Gen AI response generation system 104 is a computing device or an application server that receives or obtains the data from the plurality of data sources 102A-N to generate the Gen AI responses. The Gen AI response generation system 104 may then process and store the responses in the storage device 106. In some examples, the Gen AI response generation system 104 may include internal or external servers, quantum computers, desktops, laptops, smartphones, tablets, and/or the like. It is contemplated that implementations of the present disclosure may be realized with any appropriate type of computing device or computing platform. In some examples, the Gen AI response generation system 104 may display one or more Graphical User Interfaces (GUIs) 218 that enable the user of the user device 108 to interact or provide feedback with a computing platform evaluating the entity. Examples of the computing platform may include content delivery platforms, multimedia-based platforms, and/or the like. Interacting with the computing platform may include providing feedback during the process of generating the Gen AI responses. For example, the Gen AI response generation system 104 is described in more detail with reference to FIG. 2.

While only one Gen AI response generation system 104 is shown in FIG. 1, there may be more than one Gen AI response generation system 104, and each of the Gen AI response generation system 104 includes at least one server system. In some examples, the system hosts one or more computer implemented services that users can interact with by using the user device 108. For example, components of enterprise systems and applications can be hosted on one or more of the Gen AI response generation system 104. In some examples, the Gen AI response generation system 104 can be provided as an on-premises system that is operated by an enterprise or a third-party taking part in cross-platform interactions and data management. In some examples, the Gen AI response generation system 104 can be provided as an off-premises system (e.g., cloud or on-demand) that is operated by an enterprise or a third-party on behalf of an enterprise.

In some examples, the user device 108 may include computer executable applications executed thereon. The user device 108 may include a web browser application executed thereon, which can be used to display one or more web pages of applications executing on the Gen AI response generation system 104. In some examples, the user device 108 can display one or more GUIs that enable the respective the users to interact with the Gen AI response generation system 104 and/or to present the response generated to the input prompt. In accordance with implementations of the present disclosure, the Gen AI response generation system 104 may host enterprise applications or systems that require data sharing and data privacy.

In some implementations, the Gen AI response generation system 104 can be implemented in a cloud environment. In the example of FIG. 1, the Gen AI response generation system 104 can include various forms of servers including, but not limited to, a web server, a proxy server, a network server, and/or a server pool. In general, server systems accept requests for application services and provide such services to any number of user devices.

Further, the storage device 106 may include any standalone server or any type of computing device that is part of a cloud computing environment for storing data that is ingested by processing the input data. Various examples depicting the process of generating the Gen AI response using the context based hierarchical ontological representations are described in detail in conjunction with FIGS. 2-7.

FIG. 2 depicts an example architecture 200 of the Gen AI response generation system 104, in accordance with implementations of the present disclosure. As depicted in FIG. 2, the Gen AI response generation system 104 is communicatively coupled to a database 220 (e.g., the storage device 106) and a model database 222. For example, the database 220 can be a client database or a metadata database. In some examples, the model database 222 may include one or more Multimodal Large Language Models (multimodal LLMs) (also referenced herein as Gen AI models, foundation models, and/or the like). In an implementation, the LLMs may include pre-trained LLMs and generated LLMs. The pre-trained LLMs may be general-purpose Gen AI models like large deep learning neural networks, which may be trained using a broad range of generalized and unlabeled training data to perform one or more tasks, such as, human computer interactions (e.g., question and answering), automating process execution, process planning, generating step-by-step procedures for the process execution, performing data analysis, and/or the like. While implementations of the present disclosure are described in further detail herein with non-limiting reference to the LLMs, it is contemplated that implementations of the present disclosure may be realized using any appropriate foundation models or Machine Learning (ML) models, or AI models.

As depicted in FIG. 2, the Gen AI response generation system 104 includes a processor 202 and a memory 204. The Gen AI response generation system 104 may also include other components such as communication interfaces, Input/Output (I/O) devices, and so on (not shown in FIG. 2). The processor 202 may include one or more processors. Examples of the one or more processors may include, but not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the processor 202 may be programmed to execute computer-readable instructions or processor-readable instructions stored in the memory 204 (also referenced herein as computer-readable storage medium (CRM)) for performing operations according to the present disclosure. The memory 204 may be non-transitory or non-volatile medium, such as a magnetic disk or solid-state non-volatile memory or volatile medium such as Random Access Memory (RAM), and/or the like.

The system 104 further includes a data ingestion module 206, an embedding module 208, an ontological representation generation module 210, a validation engine 214 and a fine-tuning module 216 as depicted in FIG. 2. The data ingestion module 206, the embedding module 208, the ontological representation generator 210, the validation engine 214 and the fine-tuning module 216 may be stored in the memory 204 and provided as a downloadable library including the computer-readable instructions. The data ingestion module 206, the embedding module 208, the ontological representation generator 210, the validation engine 214 and the fine-tuning module 216 may be executed by the processor 202 communicatively coupled with the memory 204 for generating the Gen AI responses using the context based hierarchical ontological representations.

In an example implementation, the data ingestion module 206 may receive input prompt data corresponding to an enterprise from one or more data sources 102A-N. For example, the input prompt data may include a user query and user requirements in the form of structured or unstructured data. Further, the embedding module 208 may generate a query embedding vector representing the received input prompt data using an embedding model. In some examples, the query embedding vector may include a numerical representation of the input prompt data indicating a semantic meaning corresponding to the input prompt data. In an example implementation, the embedding module 208 may generate a numerical vector corresponding to the received input prompt data by applying the embedding model to a textual input comprised within the received input prompt data. Further, the embedding module 208 may encode one or more semantic relationships within the input prompt data into the generated numerical vector based on learned representations of the embedding model. The embedding module may then output the query embedding vector as a fixed-length numerical representation capturing the encoded one or more semantic relationships of the input prompt data.

Furthermore, the ontological representation generator 210 may retrieve one or more relevant nodes corresponding to the input prompt data from a pre-determined ontological representation by calculating cosine similarities between the generated query embedding vector and a plurality of embedding vectors of a plurality of nodes within the pre-determined ontological representation using a collapsed tree retrieval model. In an example implementation, the ontological representation generator 210 may calculate the cosine similarities between the generated query embedding vector and the plurality of embedding vectors of the plurality of nodes in the ontological representation using the collapsed tree retrieval model. Further, the ontological representation generator 210 ranks the plurality of nodes in the ontological representation based on the calculated cosine similarities. Furthermore, the ontological representation generator 210 may identify the one or more relevant nodes with a cosine similarity value exceeding a predefined threshold value based on the ranked plurality of nodes.

In an example implementation, to retrieve the one or more relevant nodes using the collapsed tree retrieval model, an input query q is processed through an embedding function f_{emb} (q) to generate a semantic representation e_{q}. Further, a cosine similarity is determined between the query embedding e_{q} and embeddings associated with all nodes in the ontological representation.

The embeddings may correspond to text summaries, dialogue entries, or knowledge representations stored in each node. Further, nodes with similarity scores below a predefined threshold θᵣₑₜᵣᵢₑᵥₑ are excluded from further consideration. Thus, reducing computational overhead and ensuring relevance in a final result set. The remaining nodes are then sorted based on similarity scores. The top-k nodes exhibiting the highest semantic relevance are selected and returned as the retrieval output. Therefore, the collapsed tree retrieval model is used to enhance an efficiency of memory access within the context based hierarchical ontological representation. The collapsed tree retrieval model may treat all nodes within the tree as elements of a unified set. By logically flattening a hierarchical structure for a purpose of retrieval, the ontological representation generator 210 enables a global similarity search across an entire memory space. Thus, allowing for simultaneous comparison of the input query against all stored memory nodes, thereby reducing the overhead typically associated with multi-level traversal and achieving improved retrieval speed and high semantic relevance, even in large-scale or long-context scenarios.

In addition, the ontological representation generator 210 may select a subset of nodes including the cosine similarities exceeding a predetermined retrieval threshold based on the retrieved one or more relevant nodes. In an example implementation, the ontological representation generator 210 may compute cosine similarity scores between the generated query embedding vector and the plurality of embedding vectors of the retrieved at least one relevant node. Further, the ontological representation generator 210 may determine a subset value based on one or more of a user-defined parameter (e.g., top-k most similar nodes), a system-level configuration (e.g., a threshold value for similarity score), and a query-specific requirement (e.g., minimum context coverage or semantic diversity) associated with the input prompt data. Furthermore, the ontological representation generator 210 selects the subset of nodes including the cosine similarity scores exceeding the predetermined retrieval threshold a based on the determined subset value.

Moreover, the ontological representation generator 210 may generate contextual data corresponding to the input prompt data by aggregating textual content from the selected subset of nodes. For example, the contextual data may include aggregated and summarized data. Also, the ontological representation generator 210 may generate an ontological representation corresponding to the input prompt data based on the generated contextual data. For example, the ontological representation includes a plurality of nodes comprising the textual content and the embedding vectors derived using the embedding model. In an aspect, the ontological representation generator 210 may initialize the ontological representation including the plurality of nodes. For example, each node may include the textual content, an embedding vector, a parent pointer, a set of child nodes, a root node and a depth value. The root node is configured as a structural anchor. Further, the ontological representation generator 210 may identify a node position within the ontological representation for embedding an upcoming node by calculating the cosine similarities between the embedding vector of the upcoming node and the embedding vectors of the set of child nodes at each level.

Furthermore, the ontological representation generator 210 embeds the upcoming node as a leaf node at the identified node position based on a depth-adaptive similarity threshold and the calculated cosine similarities. In addition, the ontological representation generator 210 may generate a corresponding child node for the embedded leaf node. For example, the corresponding child node may include the textual content of the leaf node. Moreover, the ontological representation generator 210 may update textual content and embedding vectors of the generated corresponding child node along a traversal path using a conditional aggregation value and based on number of descendant nodes. Also, the ontological representation generator 210 may generate an updated ontological representation corresponding to the input prompt data based on the updated textual content and updated embedding vectors. In some examples, the ontological representation is generated using multiple LLMs along with two well-known embedding models.

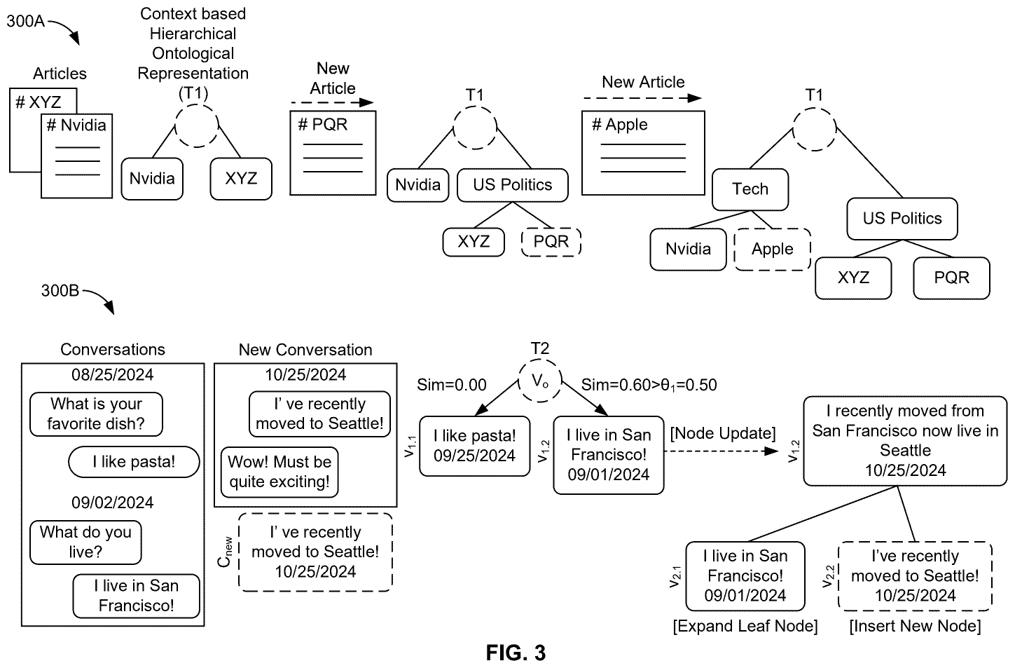

For example, the ontological representation (i.e., a context based hierarchical ontological representation) may represent a knowledge schema via as a dynamic tree structure. Parent and leaf nodes in the dynamic tree structure may store textual content and summarize information relevant to corresponding respective semantic levels. Upon receiving new information, the system 104 initiates a top-down traversal beginning at a root node. If the new information is determined to be semantically similar to an existing leaf node associated with the current traversal path, the information is routed to that corresponding leaf node for integration. If the new information does not exhibit sufficient semantic similarity to any existing leaf nodes under a current node, a new leaf node is instantiated beneath the current node, thereby terminating the traversal at that point. During the process, all ancestor nodes along a traversal path dynamically update their stored summaries to incorporate the newly received information. Thus, enabling the ontological representation to evolve in real time, facilitating efficient organization, abstraction, and retrieval of knowledge across varying levels of semantic granularity. This is explained in more detail with reference to FIG. 3.

In some examples, the system 104 employs the tree-structured, context-based hierarchical ontological representation to dynamically track and update knowledge exchanged between a user and a LLM. The context based hierarchical ontological representation inherently promotes a hierarchical organization of information, enabling the system 104 to model varying levels of abstraction effectively. Additionally, the context-based hierarchical ontological representation provides computational advantages, including logarithmic or sub-linear time complexity for insertion and traversal operations, thereby supporting real-time, online interaction scenarios.

In an example implementation, the ontological representation represents memory as a tree T=(V,E), where V is a set of nodes, and E⊆V×V is a set of directed edges representing parent-child relationships. Each node v∈V is represented as:

$$v = [ {c}_{v} , {e}_{v} , {p}_{v} , {C}_{v} , {d}_{v} ]$$

where cᵥ is textual content aggregated at a node v, eᵥ is an embedding vector derived using an embedding model f_{emb}(cᵥ), pᵥ is a parent node of the node v, Cᵥ is a set of child nodes of the node v, with edges directed from the node v to each u∈Cᵥ and dᵥ is depth of the node v from a root node v₀. The root node v₀ serves as a structural node, containing neither content nor embedding, i.e., cᵥ₀=Ø and eᵥ₀=Ø.

In an aspect, a memory updating process of the ontological representation is triggered upon observing new information (e.g., a new conversation). The process may ensure that the ontological representation (i.e., a memory tree) dynamically adapts and integrates new data while maintaining a coherent hierarchical representation. In an example implementation, to integrate the new information, a new node v_{new} with textual content c_{vnew} is created. Then, the ontological representation is traversed from the root node. At each node v, the ontological representation evaluates a semantic similarity between the new information c_{vnew} and child nodes of a current node in an embedding space. For example, the evaluation is performed by computing an embedding (c_{vnew}=f_{emb}(c_{vnew})) for the new content c_{vnew} and comparing the embedding to embeddings of the child nodes C(v) of the current node v using a cosine similarity. In an aspect, if a child node's similarity exceeds a depth-adaptive similarity threshold θ(dᵥ), traversal continues along a traversal path. If multiple child nodes' similarity exceeds the depth-adaptive similarity threshold, a path with a highest similarity score is chosen. For example, the depth-adaptive similarity threshold may ensure that deeper nodes, representing more specific information, require higher similarity for new data integration, while shallower nodes are more abstract and accept broader content. Thus, preserving the ontological representation's hierarchical integrity by adjusting selectivity based on node's depth. Further, when the traversal reaches a leaf node, the leaf node is expanded to become a parent node, accommodating both the original leaf node and v_{new} as child nodes. The parent node's content is then updated to aggregate both original leaf node's content and the new information c_{vnew}. In some examples, if all child nodes' similarities are below the threshold θ(dᵥ), then, v_{new} is directly attached as a new leaf node under the current node. For example, a similarity threshold θ(d) is adaptive based on a node's depth d, defined as:

$$θ ( d ) = {θ}_{0} {e}^{λ d}$$

where, θ₀ is a base threshold, and λ controls a rate of increase with depth.

In another example, the similarity threshold is defined as:

$$threshold = {base}_{threshold} X exp ( \frac{rate X current\_depth}{max\_depth} )$$

where, a value of the base_{threshold} is equal to 0.4, a value of the rate is equal to 0.5, the current_depth is a depth of a current node and max_depth is a maximum depth of the ontological representation.

Furthermore, once v_{new} is inserted, the content and embeddings of all parent nodes v along the traversal path are updated to reflect the new information through a conditional aggregation function or value. For example, the aggregation function, implemented as an LLM-based operation, combines existing content cᵥ with the new content c_{new}, conditioned on n (i.e., a number of descendants). As n increases, the aggregation abstracts the content further to balance the existing and new information. In this example, LLM-based operation is implemented using a prompt, such as “you will receive two pieces of information: new information is detailed, and existing information is a summary from {n child nodes} previous entries. Your task is to merge these into a single, cohesive summary that highlights the most important insights. Focus on the key points from both inputs. Ensure the final summary combines the insights from both pieces of information. If the number of previous entries in Existing Information is accumulating (more than 2), focus on summarizing more concisely, only capturing the overarching theme, and getting more abstract in your summary”.

Also, the aggregation function may ensure that a final summary combines insights from existing content cᵥ with the new content c_{new}. If a number of previous entries in the existing content is accumulating (more than 2), the aggregation is focused on summarizing more concisely, only capturing an overarching theme, and getting more abstract in the summary. Example aggregation function is defined as:

$${c}_{v}^{′} ← Aggregate ( {c}_{v} , {c}_{new} \vert n ) ,$$

where, c′ᵥ is the updated content, and n=|C(v)| is a number of descendants of the node v.

Moreover, the parent node is formatted with LLMs and embedding of the parent node is then updated ensuring that the parent node effectively represents both the new and existing information. The updating process maintains the hierarchical organization of the memory as the tree expands, enabling the ontological representation to adaptively and accurately represent the evolving conversation. Once a traversal path within the hierarchical ontological representation is determined, the aggregation of content and the corresponding embedding updates for the parent nodes along the path may be executed in parallel using one or more central processing units (CPUs). The parallelization significantly reduces processing latency during memory updates and mitigates performance bottlenecks as the size and complexity of the memory structure increase over time. For example, the embedding of the parent node is then updated as:

$${e}_{v} ← {f}_{emb} ( {c}_{v}^{′} )$$

Further, the Gen AI response generation module 212 may generate a Gen AI response to the input prompt data using one or more Gen AI models based on the generated contextual data and the generated ontological representation. In an example implementation, the Gen AI response generation module 212 may preprocess the generated contextual data, and the generated ontological representation into an input for the Gen AI model. In some examples, the preprocessing may include one or more of embedding system instructions, the user query, the contextual data, ontological information, and metadata related to relevant node. Further, the Gen AI response generation module 212 may select one or more Gen AI models from a plurality of available Gen AI models based on a criteria suitable for the input prompt data. For example, the criteria may include a model capacity, a latency, cost, a domain specialization, and a past performance for a query type. Furthermore, the Gen AI response generation module 212 may configure a plurality of processing parameters for the selected one or more Gen AI models. For example, the plurality of processing parameters may include a maximum output token count, a sampling temperature, a cumulative probability threshold value, a beam width, a beam count, and stop sequences.

In addition, the Gen AI response generation module 212 may generate one or more candidate responses to the input prompt data by invoking the selected Gen AI models with the preprocessed input and configured plurality of processing parameters. Moreover, the Gen AI response generation module 212 may generate a plurality of response scores for the one or more candidate response based on factors comprising a relevance to the input prompt data alignment with the ontological representation, consistency with the contextual data, and adherence to system instructions. Also, the Gen AI response generation module 212 may update associated with the one or more candidate responses using a ranking model based on the generated plurality of response scores. The Gen AI response generation module 212 may then select a final response from the generated one or more candidate responses based on the updated rank. Further, the Gen AI response generation module 212 may determine metadata associated with the selected final response. For example, the metadata may include information related to the selected one or more Gen AI models, the plurality of processing parameters, selected nodes, the generated plurality of response scores. The Gen AI response generation module 212 may then output the final response as the Gen AI response along with the determined metadata.

Furthermore, the validation engine 214 may validate the generated Gen AI response by comparing the Gen AI response with a reference response using one or more performance metrics. For example, the performance metrics may include one or more of accuracy-based measures, similarity-based measures, and quality assessment measures. In an example implementation, the validation engine 214 may retrieve the reference response corresponding to the input prompt data. In some example, the reference response may include one or more human-authored reference responses and one or more authorized reference responses obtained from a curated dataset. The validation engine 214 may then select one or more performance metrics from a set of metric categories including accuracy-based measures, similarity-based measures, fluency and readability measures, factuality and consistency measures, coverage and relevance measures, temporal correctness measures, safety and policy compliance measures, and human-evaluation protocols. Further, the validation engine 214 may preprocess the generated Gen AI response and each of the reference response by normalizing a text, performing a tokenization, masking formatting and personally identifiable information, and generating data representation formats required by the selected performance metrics. For example, the data representation formats may include one or more of n-gram sequences, tokenized sequences, normalized text strings, and vector embeddings generated by an embedding model.

Furthermore, the validation engine 214 may compute an accuracy score for each selected accuracy-based measure by comparing the generated Gen AI response to the reference response using one or more processes selected from one of an exact-match comparison process, an answer-span overlap process, and a binary correctness adjudication process. For example, a prompt to generate the reference response using the binary correctness adjudication process may include “Your task is to check if the predicted answer appropriately responds to the query in a similar way as the ground-truth answer. Instructions: Output ‘1’ if the predicted answer addresses the query similarly to the ground-truth answer and output ‘0’ if it does not.—Only output either ‘0’ or ‘1’. No explanations or extra text.”

In addition, the validation engine 214 may compute a similarity score for each selected similarity-based measure by performing one or more of (i) generating a precision value, a recall value, and F1 values by calculating n-gram overlap statistics data, (ii) computing an embedding-based semantic similarity score using the cosine similarity score between an embedding of the generated Gen AI response and embeddings of the reference response and (iii) generating a learned relevance score between the generated Gen AI response and each reference response by applying a cross-encoder neural model.

Moreover, the validation engine 214 extracts a plurality of candidate factual statements from the generated Gen AI response for each selected factuality and consistency measure. The validation engine 214 may then validate each of the extracted plurality of candidate factual statements with the textual content of the selected subset of nodes. Also, the validation engine 214 computes a factual-consistency score based on proportion of the extracted plurality of candidate factual statements being validated by the textual content. Further, the validation engine 214 computes one or more of language quality scores indicative of language quality for each selected fluency, readability, and stylistic measure by applying language-model-based fluency estimators, readability formulas, and token-level language-probability measures. Furthermore, the validation engine 214 computes a coverage score for each of the selected coverage and relevance measure. For example, the coverage score indicates a degree of data coverage of entities, topics, temporal anchors, and ontological elements in the Gen AI response. In an aspect, the coverage score is computed by matching extracted entities and topics with a reference set derived from the reference response and the generated ontological representation. A temporal-consistency score is then computed by extracting event sequences from the generated Gen AI response and comparing at least one of an order, timestamps, and relations of the extracted event sequences to corresponding order, timestamp, and relations present in the reference response.

In some examples, the validation engine 214 may evaluate the generated Gen AI response based on a safety policy and compute a compliance score based on detection of disallowed content, personally identifiable information, and policy violations. The validation engine 214 may aggregate the accuracy score, the factual-consistency score, the one or more language quality scores, the coverage score, and the temporal-consistency score into a validation score by applying a defined aggregation function. In an aspect, the aggregation function may include a weighted combination, a weighted average, and a learned scoring function, and the learned scoring function may be selected based on a query type, task requirements, and preconfigured importance values. Further, the validation engine 214 compares the validation score with a predefined acceptance threshold to determine whether the generated Gen AI response satisfies quality requirements. For example, the predefined acceptance threshold is dynamically adjusted based on a historical performance, a query class, and an available token budget. Furthermore, the validation engine 214 may perform one or more steps of selecting an alternative candidate response from previously generated candidate textual responses, generating follow-up prompts and re-invoking the Gen AI model using the follow-up prompts, and modifying the selected subset of nodes based on the comparison.

Also, the fine-tuning module 216 may fine-tune the one or more Gen AI models and the ontological representation based on results of the validation. In an aspect, the process of fine-tuning the ontological representation includes updating a node content and the embedding vectors. In an example implementation, the fine-tuning module 216 determines a requirement to perform fine-tuning of the one or more Gen AI models, and the ontological representation based on the results of validation and predefined fine-tuning triggers. For example, the predefined fine-tuning triggers may include one or more of a validation score below an acceptance threshold, systematic factual inconsistency rates above a factuality threshold, a recurring omission of ontological entities, a user feedback indicating unsatisfactory responses, and a scheduled periodic fine-tuning event. The fine-tuning module 216 may then determine a fine-tuning dataset including one or more of validated final responses, corresponding input prompts including the textual content and the generated ontological representation, negative examples, and provenance metadata linking each training dataset to the selected subset of nodes and cosine similarity scores.

Further, the fine-tuning module 216 may preprocess the fine-tuning dataset by performing one or more of a text normalization and tokenization, deduplication of redundant examples, anonymization and masking of personally identifiable information, a balancing of class or label distributions, and generation of input-output training pairs in a format required by selected fine-tuning procedure. Furthermore, the fine-tuning module 216 may classify the preprocessed fine-tuning dataset into training subsets, validation subsets and test subsets based on a configured split strategy. The fine-tuning module 216 may select a fine-tuning strategy for the one or more Gen AI models from among an adapter-based fine-tuning, a low-rank adaptation (Lora), an instruction tuning, and a reinforcement learning. In addition, the fine-tuning module 216 may configure fine-tuning hyperparameters and training schedules based on the selected fine-tuning strategy. For example, the fine-tuning hyperparameters and training schedules may include one or more of a learning rate, batch size, number of epochs, weight decay, gradient clipping, checkpoint frequency, early stopping criteria, and privacy constraints.

Moreover, the fine-tuning module 216 may apply the selected fine-tuning strategy to the training subset. The fine-tuning module 216 may perform iterative optimization steps including forward passes, loss computation, backpropagation, parameter updates, periodic evaluation on the reserved validation subset, and checkpointing of intermediate model states. Also, the fine-tuning module 216 may identify ontology update candidates including one or more of missing entities, missing relations, incorrect entity types, incorrect temporal anchors, mislabeled priority weights, and recurring query-to-ontology alignment errors based on the fine-tuned Gen AI model and the fine-tuned ontological representation. The fine-tuning module 216 may then identify One or more modifications to the ontological representation by one or more extracting candidate entity and relation modifications from validated final responses and from the contextual data, and derive candidate structural changes to the ontological representation. The ontological representation is then fine-tuned or modified based on the generated at least one modification to generate updated ontological representation.

FIG. 3 depicts example context based hierarchical ontological representations 300A and 300B, in accordance with implementations of the present disclosure. For example, the context based hierarchical ontological representation 300A is a tree-based memory structure that is dynamically updated based on incoming structured data (e.g., articles). The context based hierarchical ontological representation 300A is a tree-based memory structure that is dynamically updated based on incoming unstructured data (e.g., conversational data). The system leverages a tree-based memory structure to organize information across semantic hierarchies, allowing for both integration and retrieval of knowledge.

During the generation of the context based hierarchical ontological representation 300A, initially, an article referencing the topic #XYZ is processed, and nodes are created for related entities such as Nvidia and XYZ. A subsequent article related to #PQR leads to the creation of a higher-level category, US Politics, under which both XYZ and PQR are organized. When a new article referencing #Apple is ingested, the system 104 evaluates the semantic similarity of associated content with existing nodes. Since Apple is determined to be contextually distinct from US Politics, a new branch labeled Tech is instantiated. The tree structure now includes categorized branches such as Tech, US Politics, and nested nodes like XYZ, PQR, Nvidia, and Apple, reflecting an evolving semantic ontology. Thus, enhancing the system's ability to grow and restructure corresponding knowledge representation in a way that mirrors the organization of real-world domains and topics.

During the generation of the context based hierarchical ontological representation 300B, a historical conversation from Aug. 25, 2024 and Sep. 2, 2024 includes responses such as “I like pasta!” and “I live in San Francisco!”. The historical conversation is stored in leaf nodes v1 and v2 respectively. Further, a new conversation received on Oct. 25, 2024 includes the response “I've recently moved to Seattle!” (C_new). The system 104 performs semantic comparison between the new conversation and existing leaf nodes. For example, similarity between C_new and the node v1 (“I like pasta!”) is computed as 0.00, which is below the defined threshold 01=0.50. As a result, no action is taken for v1. Further, similarity between C_new and the node v2 (“I live in San Francisco!”) is 0.60, exceeding the threshold. Consequently, the system 104 performs a node update operation. During the update, the existing node v2 is expanded, and the response is enriched to reflect updated user state: “I recently moved from SF, now live in Seattle”. Both the original and new conversations may be retained at a sub-node level (v2.1 and v2.2) for traceability and historical integrity. Thus, demonstrating the system's ability to perform contextual merging of semantically related conversational entries while maintaining a coherent user memory model.

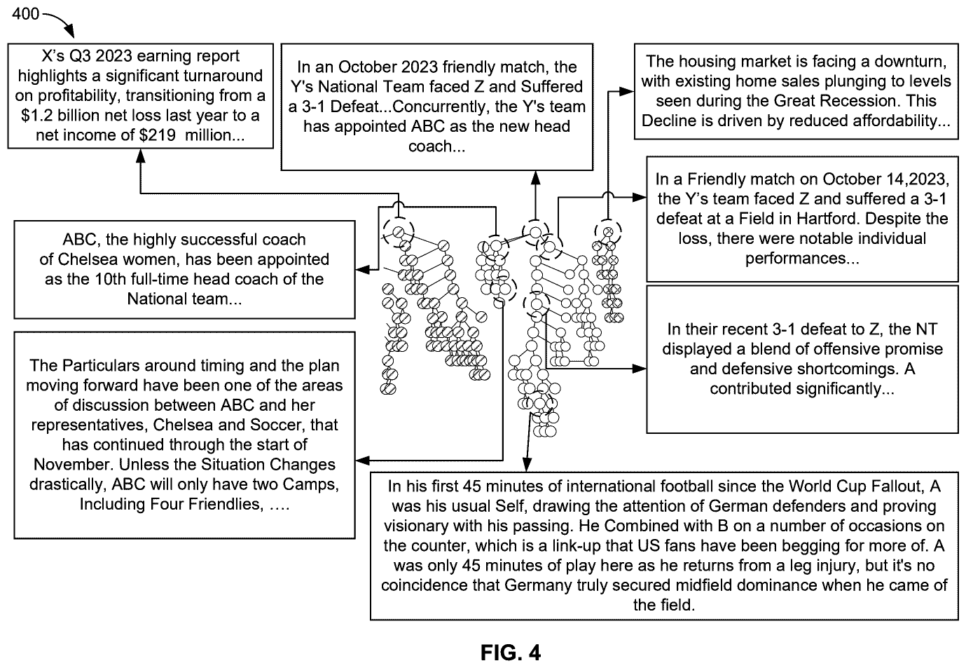

FIG. 4 depicts an example context based hierarchical ontological representation 400 generated using multi-document question answering dataset, in accordance with implementations of the present disclosure. For example, the multi-document question answering dataset includes 609 distinct news articles spanning six topical categories. The dataset consists of 2,556 multi-hop questions, each requiring the aggregation of information from multiple documents in order to formulate a comprehensive and contextually accurate response. In an aspect, the articles are processed and encoded into the context-based hierarchical ontological representation 400, forming a unified memory structure that reflects semantic relationships across the corpus. The hierarchical representation allows the system to progressively abstract and organize knowledge from general summaries at higher levels to specific factual details at deeper levels of the memory structure. As shown in the context-based hierarchical ontological representation 400, at higher levels, nodes store generalized content, such as overarching summaries of events (e.g., Y's team 3-1 loss to Z team). As traversal proceeds deeper into the structure, nodes capture increasingly specific content, such as analyses of individual player performances and tactical evaluations. Also, intermediate node contents, i.e., parent-level summaries, are generated dynamically by the system during the node update process, which involves semantic integration of child nodes based on newly ingested content.

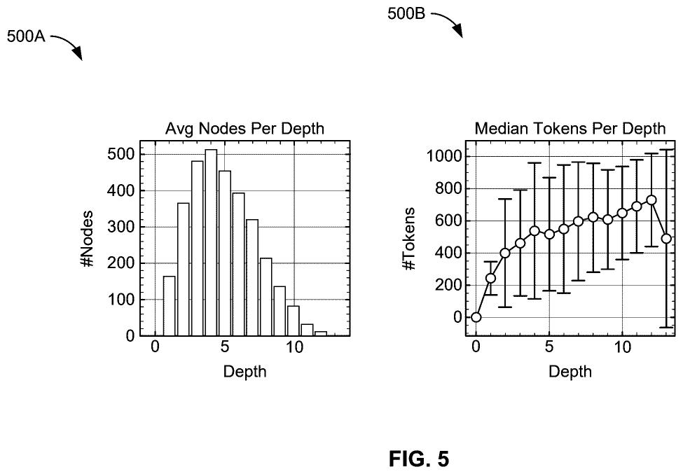

FIG. 5 depicts an example graphs 500A and 500B illustrating depth based statistics of the context based hierarchical ontological representation generated using the multi-document question answering dataset, in accordance with implementations of the present disclosure. For example, the graph 500A illustrates an average number of nodes present at each depth level of the ontological representation. As show in the graph 500A, the distribution reveals that a majority of nodes arc concentrated between depth levels 3 to 6, with a peak occurring around depth 4. This concentration indicates that the system 104 tends to organize and store semantically rich and task-relevant content within intermediate levels of the hierarchy, thereby balancing granularity with retrieval efficiency.

Further, the graph 500B displays a median number of tokens (words) stored within nodes at each depth level, along with variance represented as error bars. As shown in the graph 500B, there is a clear trend of increasing content length as depth increases. For instance, nodes at depth level 1 exhibit a median token count of slightly over 200 tokens. By contrast, nodes at depth levels and beyond reach a median of approximately 700 tokens, with noticeably higher variability.

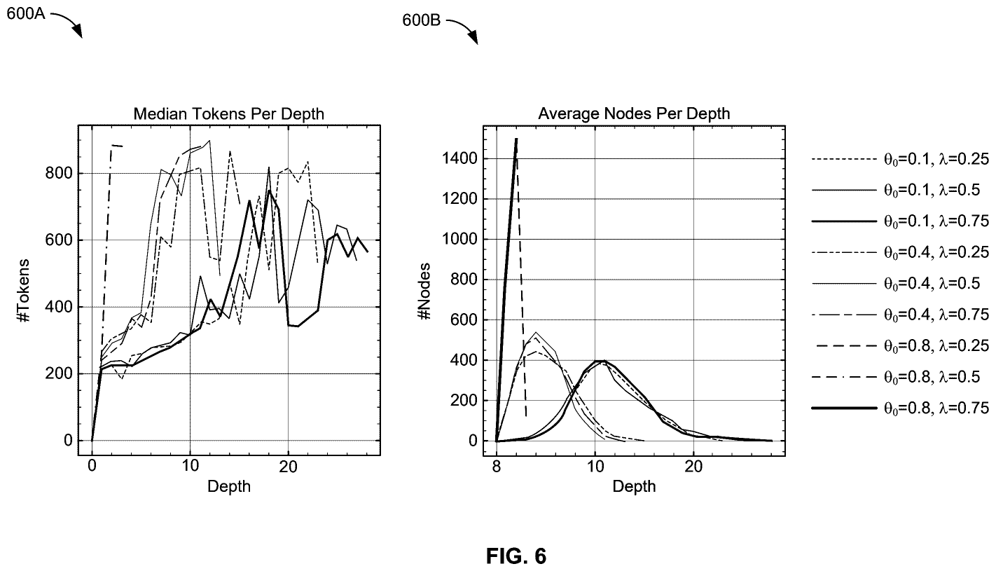

FIG. 6 depicts an example graphs 600A and 600B illustrating effect of a depth-adaptive similarity threshold on the context based hierarchical ontological representation generated using the multi-document question answering dataset, in accordance with implementations of the present disclosure. In some examples, the graphs 600A and 600B illustrates impact of two key control parameters θ₀ (i.e., a base similarity threshold) and λ (a rate parameter) on structural properties of the context based hierarchical ontological representation (i.e., a dynamic memory tree) during a multi-document question answering task. As shown in FIG. 6, the graph 600A depicts a median token count per node as a function of a depth of the ontological representation, while the graph 600B illustrates an average number of nodes per depth. The structure and depth of the tree arc highly sensitive to the choice of θ₀, which defines the similarity threshold for determining whether new information need to be integrated into an existing node or inserted as a new child node. A higher value of θ₀=0.8 enforces a stricter similarity constraint, resulting in a shallow structure where most nodes are clustered between depth levels 1 and 2. Thus, leading to a broad, horizontally expanded tree, as only highly similar inputs arc merged vertically. Further, when θ₀ is reduced to 0.4, the similarity threshold becomes more permissive, allowing the ontological representation to grow deeper. The node distribution shifts to depth levels 4-6, reflecting greater vertical expansion and more nuanced semantic organization. At θ₀ equal to 0.1, the similarity threshold is minimal, encouraging maximal vertical growth. As a result, the majority of nodes are distributed across depth levels 8-14. The increased depth enables the system to capture fine-grained distinctions between content segments. In contrast, λ, which controls the rate of similarity decay in dynamic thresholding, exerts a subtler influence on the ontological representation. Increasing λ slightly reduces the maximum depth and concentrates the node distribution. For example, when θ_{0 is equal to} 0.8, increasing λ from 0.25 to 0.75 reduces the maximum depth from 15 to approximately 11, with node distributions becoming more peaked around depth level 5. Thus, suggesting that the λ serves as a secondary tuning parameter to smooth or concentrate structural growth, whereas the θ₀ predominantly determines whether the ontological representation favors shallow or deep hierarchies.

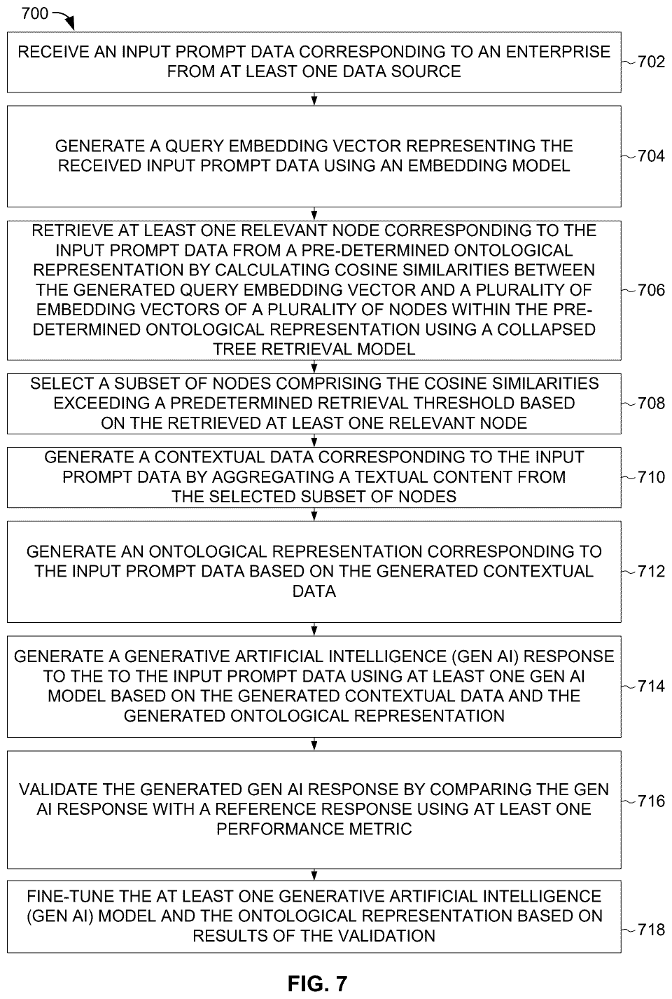

FIG. 7 is a flow diagram that represents an example processor-executable method 700 for generating Gen AI responses using context based hierarchical ontological representations, in accordance with implementations of the present disclosure. In some implementations, the method 700 may be executed by the processor 202 (including the one or more processors), as described in relation to FIGS. 2-6.

In an example implementation, the method 700 may include receiving input prompt data 702 corresponding to an enterprise from at least one data source. For example, the input prompt data may include a user query and user requirements. Further, the method 700 may include generating a query embedding vector 704 representing the received input prompt data using an embedding model. In some examples, the query embedding vector may include a numerical representation of the input prompt data indicating a semantic meaning corresponding to the input prompt data. In an example implementation, a numerical vector corresponding to the received input prompt data is generated by applying the embedding model to a textual input comprised within the received input prompt data. Further, at least one semantic relationship within the input prompt data is encoded into the generated numerical vector based on learned representations of the embedding model. The query embedding vector is then outputted as a fixed-length numerical representation capturing the encoded at least one semantic relationship of the input prompt data.

Furthermore, the method 700 may include retrieving at least one relevant node 706 corresponding to the input prompt data from a pre-determined ontological representation by calculating cosine similarities between the generated query embedding vector and a plurality of embedding vectors of a plurality of nodes within the pre-determined ontological representation using a collapsed tree retrieval model. In an example implementation, the cosine similarities between the generated query embedding vector and the plurality of embedding vectors of the plurality of nodes in the ontological representation are calculated using the collapsed tree retrieval model. Further, the plurality of nodes are ranked in the ontological representation based on the calculated cosine similarities. Furthermore, the at least one relevant node with a cosine similarity value exceeding a predefined threshold value is identified based on the ranked plurality of nodes.

In addition, the method 700 may include selecting a subset of nodes 708 including the cosine similarities exceeding a predetermined retrieval threshold based on the retrieved at least one relevant node. In an example implementation, cosine similarity scores between the generated query embedding vector and the plurality of embedding vectors of the retrieved at least one relevant node are computed. Further, a subset value is determined based on one or more of a user-defined parameter, a system configuration, and a query-specific requirement associated with the input prompt data. Furthermore, the subset of nodes including the cosine similarity scores exceeding the predetermined retrieval threshold are selected based on the determined subset value.

Moreover, the method 700 may include generating contextual data 710 corresponding to the input prompt data by aggregating textual content from the selected subset of nodes. Also, the method 700 may include generating an ontological representation 712 corresponding to the input prompt data based on the generated contextual data. For example, ontological representation includes a plurality of nodes comprising the textual content and the embedding vectors derived using the embedding model. In an aspect, the ontological representation including the plurality of nodes is initialized. For example, each node may include the textual content, an embedding vector, a parent pointer, a set of child nodes, a root node and a depth value. The root node being configured as a structural anchor. Further, a node position within the ontological representation is identified for embedding an upcoming node by calculating the cosine similarities between the embedding vector of the upcoming node and the embedding vectors of the set of child nodes at each level. Furthermore, the upcoming node is embedded as a leaf node at the identified node position based on a depth-adaptive similarity threshold and based on the calculated cosine similarities. In addition, a corresponding child node is generated for the embedded leaf node. For example, the corresponding child node may include the textual content of the leaf node. Moreover, textual content and embedding vectors of the generated corresponding child node along a traversal path are updated using a conditional aggregation value and based on number of descendant nodes. Also, an updated ontological representation corresponding to the input prompt data is generated based on the updated textual content and updated embedding vectors.

Further, the method 700 may include generating a Gen AI response 714 to the input prompt data using at least one Gen AI model based on the generated contextual data and the generated ontological representation. In an example implementation, the generated contextual data, and the generated ontological representation are preprocessed into an input for the Gen AI model. In some examples, the preprocessing may include at least one of embedding system instructions, the user query, the contextual data, ontological information, and metadata related to relevant node. Further, at least one Gen AI model is selected from a plurality of available Gen AI models based on a criteria suitable for the input prompt data. The criteria may include a model capacity, a latency, cost, a domain specialization, and a past performance for a query type. Furthermore, a plurality of processing parameters are configured for the selected at least one Gen AI model. For example, the plurality of processing parameters may include a maximum output token count, a sampling temperature, a cumulative probability threshold value, a beam width, a beam count, and stop sequences. In addition, one or more candidate responses are generated to the input prompt data by invoking the selected Gen AI model with the preprocessed input and configured plurality of processing parameters. Moreover, a plurality of response scores are generated for the one or more candidate response based on factors comprising a relevance to the input prompt data alignment with the ontological representation, consistency with the contextual data, and adherence to system instructions. Also, ranks associated with the one or more candidate responses are updated using a ranking model based on the generated plurality of response scores. A final response is then selected from the generated at least one candidate response based on the updated at least one rank. Further, metadata associated with the selected final response is determined. For example, the metadata may include information related to the selected one or more Gen AI models, the plurality of processing parameters, selected nodes, the generated plurality of response scores. The final response is then outputted as the Gen AI response along with the determined metadata.

Furthermore, the method 700 may include validating 716 the generated Gen AI response by comparing the Gen AI response with a reference response using at least one performance metric. For example, the at least one performance metric may include at least one of accuracy-based measures, similarity-based measures, and quality assessment measures. In an example implementation, the reference response corresponding to the input prompt data is retrieved. In some example, the reference response may include one or more human-authored reference responses and one or more authorized reference responses obtained from a curated dataset. The one or more performance metrics are then selected from a set of metric categories including accuracy-based measures, similarity-based measures, fluency and readability measures, factuality and consistency measures, coverage and relevance measures, temporal correctness measures, safety and policy compliance measures, and human-evaluation protocols. Further, the generated Gen AI response and each of the reference response are preprocessed by normalizing a text, performing a tokenization, masking formatting and personally identifiable information, and generating data representation formats required by the selected performance metrics. For example, the data representation formats may include one or more of n-gram sequences, tokenized sequences, normalized text strings, and vector embeddings generated by an embedding model.

Furthermore, an accuracy score for each selected accuracy-based measure is computed by comparing the generated Gen AI response to the reference response using one or more processes selected from one of an exact-match comparison process, an answer-span overlap process, and a binary correctness adjudication process. In addition, a similarity score for each selected similarity-based measure is computed by performing one or more of (i) generating a precision value, a recall value, and F1 values by calculating n-gram overlap statistics data, (ii) computing an embedding-based semantic similarity score using the cosine similarity score between an embedding of the generated Gen AI response and embeddings of the reference response and (iii) generating a learned relevance score between the generated Gen AI response and each reference response by applying a cross-encoder neural model.

Moreover, a plurality of candidate factual statements are extracted from the generated Gen AI response for each selected factuality and consistency measure. Each of the extracted plurality of candidate factual statements is then validated with the textual content of the selected subset of nodes. Also, a factual-consistency score is computed based on proportion of the extracted plurality of candidate factual statements being validated by the textual content. Further, one or more of language quality scores indicative of language quality for each selected fluency, readability, and stylistic measure are computed by applying language-model-based fluency estimators, readability formulas, and token-level language-probability measures. Furthermore, a coverage score is computed for each of the selected coverage and relevance measure. For example, the coverage score indicates a degree of data coverage of entities, topics, temporal anchors, and ontological elements in the Gen AI response. In an aspect, the coverage score is computed by matching extracted entities and topics with a reference set derived from the reference response and the generated ontological representation. A temporal-consistency score is then computed by extracting event sequences from the generated Gen AI response and comparing at least one of an order, timestamps, and relations of the extracted event sequences to corresponding order, timestamp, and relations present in the reference response.

In some examples, the generated Gen AI response is evaluated based on a safety policy and computing a compliance score based on detection of disallowed content, personally identifiable information, and policy violations. The accuracy score, the factual-consistency score, the one or more language quality scores, the coverage score, and the temporal-consistency score are aggregated into a validation score by applying a defined aggregation function. In an aspect, the aggregation function may include a weighted combination, a weighted average, and a learned scoring function, and the learned scoring function may be selected based on a query type, task requirements, and preconfigured importance values. Further, the validation score is compared with a predefined acceptance threshold to determine whether the generated Gen AI response satisfies quality requirements. For example, the predefined acceptance threshold is dynamically adjusted based on a historical performance, a query class, and an available token budget. Furthermore, one or more steps of selecting an alternative candidate response from previously generated candidate textual responses, generating follow-up prompts and re-invoking the Gen AI model using the follow-up prompts, and modifying the selected subset of nodes based on the comparison are performed.

Also, the method 700 may include fine-tuning 718 the one or more Gen AI models and the ontological representation based on results of the validation. In an aspect, the process of fine-tuning the ontological representation includes updating a node content and the embedding vectors. In an example implementation, a requirement to perform fine-tuning of the one or more Gen AI models, and the ontological representation is determined based on the results of validation and predefined fine-tuning triggers. The predefined fine-tuning triggers may include one or more of a validation score below an acceptance threshold, systematic factual inconsistency rates above a factuality threshold, a recurring omission of ontological entities, a user feedback indicating unsatisfactory responses, and a scheduled periodic fine-tuning event. A fine-tuning dataset is then determined. The fine-tuning dataset may include one or more of validated final responses, corresponding input prompts including the textual content and the generated ontological representation, negative examples, and provenance metadata linking each training dataset to the selected subset of nodes and cosine similarity scores.

Further, the fine-tuning dataset is then preprocessed by performing one or more of a text normalization and tokenization, deduplication of redundant examples, anonymization and masking of personally identifiable information, a balancing of class or label distributions, and generation of input-output training pairs in a format required by selected fine-tuning procedure. Furthermore, the preprocessed fine-tuning dataset is classified into training subsets, validation subsets and test subsets based on a configured split strategy. A fine-tuning strategy is then selected for the one or more Gen AI models from among an adapter-based fine-tuning, a low-rank adaptation (Lora), an instruction tuning, and a reinforcement learning. In addition, fine-tuning hyperparameters and training schedules are configured based on the selected fine-tuning strategy. For example, the fine-tuning hyperparameters and training schedules may include one or more of a learning rate, batch size, number of epochs, weight decay, gradient clipping, checkpoint frequency, early stopping criteria, and privacy constraints.

Moreover, the selected fine-tuning strategy is applied to the training subset. Iterative optimization steps including forward passes, loss computation, backpropagation, parameter updates, periodic evaluation on the reserved validation subset, and checkpointing of intermediate model states are performed. Also, ontology update candidates including one or more of missing entities, missing relations, incorrect entity types, incorrect temporal anchors, mislabeled priority weights, and recurring query-to-ontology alignment errors are identified based on the fine-tuned Gen AI model and the fine-tuned ontological representation. One or more modifications to the ontological representation are identified by one or more extracting candidate entity and relation modifications from validated final responses and from the contextual data, and deriving candidate structural changes to the ontological representation. The ontological representation is then fine-tuned or modified based on the generated at least one modification to generate updated ontological representation.

Implementations of the present disclosure may provide a technique that is designed to emulate schema-like structures observed in human cognition by maintaining a dynamically structured memory representation throughout ongoing interactions. The technique is implemented using context-based hierarchical ontological representations, which enable the system to adaptively organize and retrieve information based on semantic relevance and contextual structure.

In the present disclosure, each unit of memory is represented as a node within a hierarchical tree. Each node encapsulates semantic information and maintains explicit links to corresponding child nodes, thereby reflecting a nested and context-sensitive organization of knowledge. The structure may support dynamic memory expansion and semantic abstraction as information is aggregated over time.

Further, when new information is encountered, the memory structure is updated beginning from a root node. At each level, the technique determines whether to instantiate a new child node or to integrate the new information into an existing child node. This decision-making process is governed by a traversal algorithm that compares semantic embeddings of the new content against those of existing nodes, allowing for selective and efficient memory modification. This complexity ensures that the structure remains scalable and responsive even during extended use. Also, parent nodes in the hierarchy progressively accumulate and abstract semantic content from associated child nodes, resulting in a multi-level knowledge structure. This enables the system to reason over high-level concepts while retaining access to fine-grained details at lower levels of the hierarchy.

For information retrieval, the system computes cosine similarity between the semantic embedding of a user query and the embeddings associated with nodes in the hierarchy. This retrieval mechanism preserves time complexity comparable to conventional memory augmentation methods, such as flat vector stores or lookup tables, while significantly improving the semantic relevance and contextual precision of the retrieved information. Also, the implementations of the present disclosure may integrate new data dynamically in real-time, without requiring reconstruction of the entire memory structure. This capability makes the technique particularly well-suited for applications involving real-time or continuous interactions.

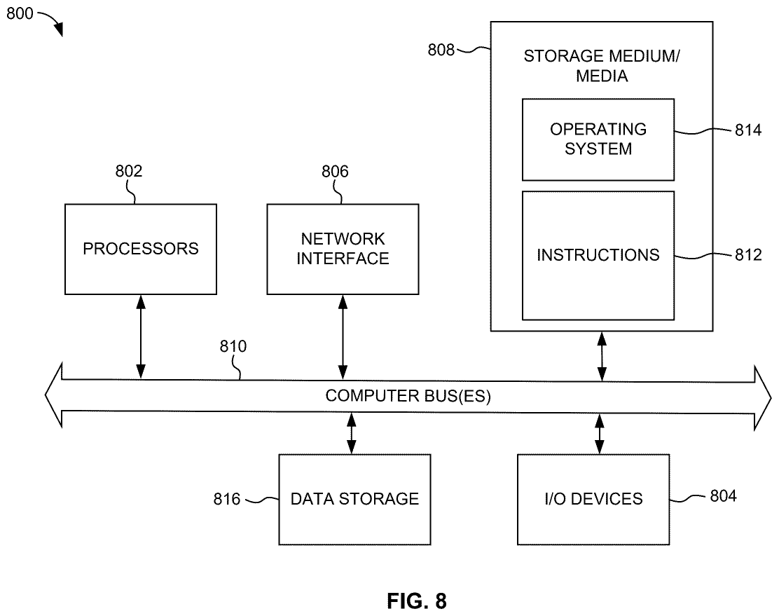

FIG. 8 illustrates a computer system 800 (i.e., the Gen AI response generation system 104) that may be used to implement the method for generating Gen AI responses using context based hierarchical ontological representations, in accordance with implementations of the present disclosure. More particularly, computing machines such as desktops, laptops, smartphones, tablets, and wearables which may be used to perform the software testing. The computer system 800 may include additional components not shown and that some of the process components described may be removed and/or modified. In another example, a computer system 800 may be deployed on external-cloud platforms such as cloud, internal corporate cloud computing clusters, organizational computing resources, and/or the like.

The computer system 800 includes processor(s) 802, such as a central processing unit, ASIC or another type of processing circuit, input/output devices 804, such as a display, mouse keyboard, etc., a network interface 806, such as a Local Area Network (LAN), a wireless 802.11x LAN, a 3G or 4G mobile WAN or a WiMax WAN, and a computer-readable medium 808. Each of these components may be operatively coupled to a bus 810. The computer-readable medium 808 may be any suitable medium that participates in providing instructions to the processor(s) 802 for execution. For example, the computer-readable medium 808 may be non-transitory or non-volatile medium, such as a magnetic disk or solid-state non-volatile memory or volatile medium such as RAM. The instructions or modules stored on the computer-readable medium 808 may include machine-readable instructions 812 executed by the processor(s) 802 that cause the processor(s) 802 to perform the methods and functions of the system 104.

The system 800 may be implemented as software stored on a non-transitory processor-readable medium and executed by the processor(s) 802. For example, the computer-readable medium 808 may store an operating system 814, such as MAC OS, MS WINDOWS, UNIX, or LINUX, and code, for the system 800. The operating system 814 may be multi-user, multiprocessing, multitasking, multithreading, real-time, and the like. For example, during runtime, the operating system 814 is running and the code for the computer system 800 is executed by the processor(s) 802.

The computer system 800 may include a data storage 816, which may include non-volatile data storage. The data storage 816 stores any data used or generated by the system 104. The network interface 806 connects the computer system 800 to internal systems for example, via a LAN. Also, the network interface 806 may connect the computer system 800 to the Internet. For example, the computer system 800 may connect to web browsers and other external applications and systems via the network interface 806.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, the AI agentic system). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 802 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet. The computing system may include clients and servers. A client and server are generally remote from each other and interact through a communication network. The relationship between client and server arises by virtue of computer programs running on the respective computers and having a client-server relationship with each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination with a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together into a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive input prompt data corresponding to an enterprise from at least one data source, wherein the input prompt data comprises a user query and user requirements;
generate a query embedding vector representing the received input prompt data using an embedding model, wherein the query embedding vector comprises a numerical representation of the input prompt data indicating a semantic meaning corresponding to the input prompt data;
retrieve at least one relevant node corresponding to the input prompt data from a pre-determined ontological representation by calculating cosine similarities between the generated query embedding vector and a plurality of embedding vectors of a plurality of nodes within the pre-determined ontological representation using a collapsed tree retrieval model;
select a subset of nodes comprising the cosine similarities exceeding a predetermined retrieval threshold based on the retrieved at least one relevant node;
generate contextual data corresponding to the input prompt data by aggregating textual content from the selected subset of nodes;
generate an ontological representation corresponding to the input prompt data based on the generated contextual data, wherein the ontological representation comprises a plurality of nodes comprising the textual content and the embedding vectors derived using the embedding model;
generate a Generative Artificial Intelligence (Gen AI) response to the input prompt data using at least one Gen AI model based on the generated contextual data and the generated ontological representation;
validate the generated Gen AI response by comparing the Gen AI response with a reference response using at least one performance metric, wherein the at least one performance metric comprises at least one of accuracy-based measures, similarity-based measures, and quality assessment measures; and
fine-tune the at least one Gen AI model and the ontological representation based on results of the validation, wherein the fine-tuning of the ontological representation comprises updating a node content and the embedding vectors.

2. The system of claim 1, wherein to generate the query embedding vector representing the received input prompt data using the embedding model, the processor is to:
generate a numerical vector corresponding to the received input prompt data by applying the embedding model to a textual input comprised within the received input prompt data;
encode at least one semantic relationship within the input prompt data into the generated numerical vector based on learned representations of the embedding model; and
output the query embedding vector as a fixed-length numerical representation capturing the encoded at least one semantic relationship of the input prompt data.

3. The system of claim 1, wherein to retrieve the at least one relevant node corresponding to the input prompt data from the pre-determined ontological representation, the processor is to:
calculate the cosine similarities between the generated query embedding vector and the plurality of embedding vectors of the plurality of nodes in the ontological representation using the collapsed tree retrieval model;
rank the plurality of nodes in the ontological representation based on the calculated cosine similarities; and
identify the at least one relevant node with a cosine similarity value exceeding a predefined threshold value based on the ranked plurality of nodes.

4. The system of claim 1, wherein to generate the ontological representation corresponding to the input prompt data based on the generated contextual data, the processor is to:
initialize the ontological representation comprising the plurality of nodes, wherein each node comprises the textual content, an embedding vector, a parent pointer, a set of child nodes, a root node, and a depth value, wherein the root node being configured as a structural anchor;
identify a node position within the ontological representation for embedding an upcoming node by calculating the cosine similarities between the embedding vector of the upcoming node and the embedding vectors of the set of child nodes at each level;
embed the upcoming node as a leaf node at the identified node position based on a depth-adaptive similarity threshold and based on the calculated cosine similarities;
generate a corresponding child node for the embedded leaf node, wherein the corresponding child node comprises the textual content of the leaf node;
update textual content and embedding vectors of the generated corresponding child node along a traversal path using a conditional aggregation value and based on number of descendant nodes; and
generate an updated ontological representation corresponding to the input prompt data based on the updated textual content and updated embedding vectors.

5. The system of claim 1, wherein to select the subset of nodes comprising the cosine similarities exceeding the predetermined retrieval threshold based on the retrieved at least one relevant node, the processor is to:
compute cosine similarity scores between the generated query embedding vector and the plurality of embedding vectors of the retrieved at least one relevant node;
determine a subset value based on at least one of a user-defined parameter, a system configuration, and a query-specific requirement associated with the input prompt data; and
select the subset of nodes comprising the cosine similarity scores exceeding the predetermined retrieval threshold based on the determined subset value.

6. The system of claim 1, wherein to generate the Gen AI response to the input prompt data using the at least one Gen AI model based on the generated contextual data and the generated ontological representation, the processor is to:
preprocess the generated contextual data and the generated ontological representation into an input for the Gen AI model, wherein the preprocessing comprises at least one of embedding system instructions, the user query, the contextual data, ontological information, and metadata related to relevant node;
select at least one Gen AI model from a plurality of available Gen AI models based on a criteria suitable for the input prompt data, wherein the criteria comprise a model capacity, a latency, cost, a domain specialization, and a past performance for a query type;
configure a plurality of processing parameters for the selected at least one Gen AI model, wherein the plurality of processing parameters comprise a maximum output token count, a sampling temperature, a cumulative probability threshold value, a beam width, a beam count, and stop sequences;
generate at least one candidate response to the input prompt data by invoking the selected Gen AI model with the preprocessed input and configured plurality of processing parameters;
generate a plurality of response scores for the generated at least one candidate response based on factors comprising a relevance to the input prompt data alignment with the ontological representation, consistency with the contextual data, and adherence to system instructions;
update at least one rank associated with the generated at least one candidate response using a ranking model based on the generated plurality of response scores;
select a final response from the generated at least one candidate response based on the updated at least one rank;
determine metadata associated with the selected final response, wherein the metadata comprises information related to the selected at least one Gen AI model, the plurality of processing parameters, selected nodes, the generated plurality of response scores; and
output the final response as the Generative Artificial Intelligence (Gen AI) response along with the determined metadata.

7. The system of claim 1, wherein to validate the generated Gen AI response by comparing the Gen AI response with the reference response using the at least one performance metric, the processor is to:
retreive the reference response corresponding to the input prompt data, wherein the reference response comprises at least one human-authored reference response and at least one authorized reference response obtained from a curated dataset;
select the at least one performance metric from a set of metric categories comprising accuracy-based measures, similarity-based measures, fluency and readability measures, factuality and consistency measures, coverage and relevance measures, temporal correctness measures, safety and policy compliance measures, and human-evaluation protocols;
preprocess the generated Gen AI response and each of the reference response by normalizing a text, performing a tokenization, masking formatting and personally identifiable information, and generating data representation formats required by the selected performance metrics, wherein the data representation formats comprise at least one of n-gram sequences, tokenized sequences, normalized text strings, and vector embeddings generated by an embedding model;
compute an accuracy score for each selected accuracy-based measure by comparing the generated Gen AI response to the reference response using at least one process selected from one of an exact-match comparison process, an answer-span overlap process, and a binary correctness adjudication process;
compute a similarity score for each selected similarity-based measure by performing at least one of:
generate a precision value, a recall value, and F1 values by calculating n-gram overlap statistics data;
compute an embedding-based semantic similarity score using the cosine similarity score between an embedding of the generated Gen AI response and embeddings of the reference response; and
generate a learned relevance score between the generated Gen AI response and each reference response by applying a cross-encoder neural model;
extract a plurality of candidate factual statements from the generated Gen AI response for each selected factuality and consistency measure;
validate each of the extracted plurality of candidate factual statements with the textual content of the selected subset of nodes;
compute a factual-consistency score based on proportion of the extracted plurality of candidate factual statements being validated by the textual content;
compute at least one language quality score indicative of language quality for each selected fluency, readability, and stylistic measure by applying language-model-based fluency estimators, readability formulas, and token-level language-probability measures;
compute a coverage score for each of the selected coverage and relevance measure, wherein the coverage score indicates a degree of data coverage of entities, topics, temporal anchors, and ontological elements in the Gen AI response, and wherein the coverage score being computed by matching extracted entities and topics with a reference set derived from the reference response and the generated ontological representation; and
compute a temporal-consistency score by extracting event sequences from the generated Gen AI response and comparing at least one of an order, timestamps, and relations of the extracted event sequences to corresponding order, timestamp, and relations present in the reference response.

8. The system of claim 7, wherein the processor further is to:
evaluate the generated Gen AI response based on a safety policy and computing a compliance score based on detection of disallowed content, personally identifiable information, and policy violations;
aggregate the accuracy score, the factual-consistency score, the at least one language quality score, the coverage score, and the temporal-consistency score into a validation score by applying a defined aggregation function, wherein the aggregation function comprises a weighted combination, a weighted average, and a learned scoring function, and wherein the learned scoring function being selected based on a query type, task requirements, and preconfigured importance values;
compare the validation score with a predefined acceptance threshold to determine whether the generated Gen AI response satisfies quality requirements, wherein the predefined acceptance threshold being dynamically adjusted based on a historical performance, a query class, and an available token budget; and
perform at least one of selecting an alternative candidate response from previously generated candidate textual responses, generating follow-up prompts and re-invoking the Gen AI model using the follow-up prompts, and modifying the selected subset of nodes based on the comparison.

9. The system of claim 1, wherein to fine-tune the at least one Gen AI model and the ontological representation based on results of the validation, the processor is to:
determine a requirement to perform fine-tuning of the at least one Gen AI model, and the ontological representation based on the results of validation and predefined fine-tuning triggers, wherein the predefined fine-tuning triggers comprise at least one of validation score below an acceptance threshold, systematic factual inconsistency rates above a factuality threshold, a recurring omission of ontological entities, a user feedback indicating unsatisfactory responses, and a scheduled periodic fine-tuning event;
determine a fine-tuning dataset comprising at least one of validated final responses, corresponding input prompts comprising the textual content and the generated ontological representation, negative examples, and provenance metadata linking each training dataset to the selected subset of nodes and cosine similarity scores;
preprocess the fine-tuning dataset by performing at least one of a text normalization and tokenization, deduplication of redundant examples, anonymization and masking of personally identifiable information, a balancing of class or label distributions, and generation of input-output training pairs in a format required by selected fine-tuning procedure;
classify the preprocessed fine-tuning dataset into training subsets, validation subsets and test subsets based on a configured split strategy;
select a fine-tuning strategy for the at least one Gen AI model from among an adapter-based fine-tuning, a low-rank adaptation (Lora), an instruction tuning, and a reinforcement learning;
configure fine-tuning hyperparameters and training schedules based on the selected fine-tuning strategy, wherein the fine-tuning hyperparameters and training schedules comprise at least a learning rate, batch size, number of epochs, weight decay, gradient clipping, checkpoint frequency, early stopping criteria, and privacy constraints;
apply the selected fine-tuning strategy to the training subset, performing iterative optimization steps comprising forward passes, loss computation, backpropagation, parameter updates, periodic evaluation on the reserved validation subset, and checkpointing of intermediate model states;
identify ontology update candidates comprising at least one of: missing entities, missing relations, incorrect entity types, incorrect temporal anchors, mislabeled priority weights, and recurring query-to-ontology alignment errors based on the fine-tuned Gen AI model and the fine-tuned ontological representation;
generate at least one modification to the ontological representation by at least one extracting candidate entity and relation modifications from validated final responses and from the contextual data, and deriving candidate structural changes to the ontological representation; and
modify the ontological representation based on the generated at least one modification to generate updated ontological representation.

10. A method comprising:
receiving, by a processor, input prompt data corresponding to an enterprise from at least one data source, wherein the input prompt data comprises a user query and user requirements;
generating, by the processor, a query embedding vector representing the received input prompt data using an embedding model, wherein the query embedding vector comprises a numerical representation of the input prompt data indicating a semantic meaning corresponding to the input prompt data;
retrieving, by the processor, at least one relevant node corresponding to the input prompt data from a pre-determined ontological representation by calculating cosine similarities between the generated query embedding vector and a plurality of embedding vectors of a plurality of nodes within the pre-determined ontological representation using a collapsed tree retrieval model;
selecting, by the processor, a subset of nodes comprising the cosine similarities exceeding a predetermined retrieval threshold based on the retrieved at least one relevant node;
generating, by the processor, contextual data corresponding to the input prompt data by aggregating textual content from the selected subset of nodes;
generating, by the processor, an ontological representation corresponding to the input prompt data based on the generated contextual data, wherein the ontological representation comprises a plurality of nodes comprising the textual content and the embedding vectors derived using the embedding model;
generating, by the processor, a Generative Artificial Intelligence (Gen AI) response to the input prompt data using at least one Gen AI model based on the generated contextual data and the generated ontological representation;
validating, by the processor, the generated Gen AI response by comparing the Gen AI response with a reference response using at least one performance metric, wherein the at least one performance metric comprises at least one of accuracy-based measures, similarity-based measures, and quality assessment measures; and
fine-tuning, by the processor, the at least one Gen AI model and the ontological representation based on results of the validation, wherein the fine-tuning of the ontological representation comprises updating a node content and the embedding vectors.

11. The method of claim 10, wherein generating the query embedding vector representing the received input prompt data using the embedding model comprises:
generating, by the processor, a numerical vector corresponding to the received input prompt data by applying the embedding model to a textual input comprised within the received input prompt data;
encoding, by the processor, at least one semantic relationship within the input prompt data into the generated numerical vector based on learned representations of the embedding model; and
outputting, by the processor, the query embedding vector as a fixed-length numerical representation capturing the encoded at least one semantic relationship of the input prompt data.

12. The method of claim 10, wherein retrieving the at least one relevant node corresponding to the input prompt data from the pre-determined ontological representation comprises:
calculating, by the processor, the cosine similarities between the generated query embedding vector and the plurality of embedding vectors of the plurality of nodes in the ontological representation using the collapsed tree retrieval model;
ranking, by the processor, the plurality of nodes in the ontological representation based on the calculated cosine similarities; and
identifying, by the processor, the at least one relevant node with a cosine similarity value exceeding a predefined threshold value based on the ranked plurality of nodes.

13. The method of claim 10, wherein generating the ontological representation corresponding to the input prompt data based on the generated contextual data comprises:
initializing, by the processor, the ontological representation comprising the plurality of nodes, wherein each node comprises the textual content, an embedding vector, a parent pointer, a set of child nodes, a root node and a depth value, wherein the root node being configured as a structural anchor;
identifying, by the processor, a node position within the ontological representation for embedding an upcoming node by calculating the cosine similarities between the embedding vector of the upcoming node and the embedding vectors of the set of child nodes at each level;
embedding, by the processor, the upcoming node as a leaf node at the identified node position based on a depth-adaptive similarity threshold and based on the calculated cosine similarities;
generating, by the processor, a corresponding child node for the embedded leaf node, wherein the corresponding child node comprises the textual content of the leaf node;
updating, by the processor, textual content and embedding vectors of the generated corresponding child node along a traversal path using a conditional aggregation value and based on number of descendant nodes; and
generating, by the processor, an updated ontological representation corresponding to the input prompt data based on the updated textual content and updated embedding vectors.

14. The method of claim 10, wherein selecting the subset of nodes comprising the cosine similarities exceeding the predetermined retrieval threshold based on the retrieved at least one relevant node comprises:
computing, by the processor, cosine similarity scores between the generated query embedding vector and the plurality of embedding vectors of the retrieved at least one relevant node;
determining, by the processor, a subset value based on at least one of a user-defined parameter, a system configuration, and a query-specific requirement associated with the input prompt data; and
selecting, by the processor, the subset of nodes comprising the cosine similarity scores exceeding the predetermined retrieval threshold based on the determined subset value.

15. The method of claim 10, wherein generating the Gen AI response to the input prompt data using the at least one Gen AI model based on the generated contextual data and the generated ontological representation comprises:
preprocessing, by the processor, the generated contextual data, and the generated ontological representation into an input for the Gen AI model, wherein the preprocessing comprises at least one of embedding system instructions, the user query, the contextual data, ontological information, and metadata related to relevant node;
selecting, by the processor, at least one Gen AI model from a plurality of available Gen AI models based on a criteria suitable for the input prompt data, wherein the criteria comprise a model capacity, a latency, cost, a domain specialization, and a past performance for a query type;
configuring, by the processor, a plurality of processing parameters for the selected at least one Gen AI model, wherein the plurality of processing parameters comprise a maximum output token count, a sampling temperature, a cumulative probability threshold value, a beam width, a beam count, and stop sequences;
generating, by the processor, at least one candidate response to the input prompt data by invoking the selected Gen AI model with the preprocessed input and configured plurality of processing parameters;
generating, by the processor, a plurality of response scores for the generated at least one candidate response based on factors comprising a relevance to the input prompt data alignment with the ontological representation, consistency with the contextual data, and adherence to system instructions;
updating, by the processor, at least one rank associated with the generated at least one candidate response using a ranking model based on the generated plurality of response scores;
selecting, by the processor, a final response from the generated at least one candidate response based on the updated at least one rank;
determining, by the processor, metadata associated with the selected final response, wherein the metadata comprises information related to the selected at least one Gen AI model, the plurality of processing parameters, selected nodes, the generated plurality of response scores; and
outputting, by the processor, the final response as the Gen AI response along with the determined metadata.

16. The method of claim 10, wherein validating the generated Gen AI response by comparing the Gen AI response with the reference response using the at least one performance metric comprises:
retrieving, by the processor, the reference response corresponding to the input prompt data, wherein the reference response comprises at least one human-authored reference response and at least one authorized reference response obtained from a curated dataset;
selecting, by the processor, the at least one performance metric from a set of metric categories comprising accuracy-based measures, similarity-based measures, fluency and readability measures, factuality and consistency measures, coverage and relevance measures, temporal correctness measures, safety and policy compliance measures, and human-evaluation protocols;
preprocessing, by the processor, the generated Gen AI response and each of the reference response by normalizing a text, performing a tokenization, masking formatting and personally identifiable information, and generating data representation formats required by the selected performance metrics, wherein the data representation formats comprise at least one of n-gram sequences, tokenized sequences, normalized text strings, and vector embeddings generated by an embedding model;
computing, by the processor, an accuracy score for each selected accuracy-based measure by comparing the generated Gen AI response to the reference response using at least one process selected from one of an exact-match comparison process, an answer-span overlap process, and a binary correctness adjudication process;
computing, by the processor, a similarity score for each selected similarity-based measure by performing at least one of:
generating, by the processor, a precision value, a recall value, and F1 values by calculating n-gram overlap statistics data;
computing, by the processor, an embedding-based semantic similarity score using the cosine similarity score between an embedding of the generated Gen AI response and embeddings of the reference response; and
generating, by the processor, a learned relevance score between the generated Gen AI response and each reference response by applying a cross-encoder neural model;
extracting, by the processor, a plurality of candidate factual statements from the generated Gen AI response for each selected factuality and consistency measure;
validating, by the processor, each of the extracted plurality of candidate factual statements with the textual content of the selected subset of nodes;
computing, by the processor, a factual-consistency score based on proportion of the extracted plurality of candidate factual statements being validated by the textual content; computing, by the processor, at least one language quality score indicative of language quality for each selected fluency, readability, and stylistic measure by applying language-model-based fluency estimators, readability formulas, and token-level language-probability measures;
computing, by the processor, a coverage score for each of the selected coverage and relevance measure, wherein the coverage score indicates a degree of data coverage of entities, topics, temporal anchors, and ontological elements in the Gen AI response, and wherein the coverage score being computed by matching extracted entities and topics with a reference set derived from the reference response and the generated ontological representation; and
computing, by the processor, a temporal-consistency score by extracting event sequences from the generated Gen AI response and comparing at least one of an order, timestamps, and relations of the extracted event sequences to corresponding order, timestamp, and relations present in the reference response.

17. The method of claim 16, further comprising:
evaluating, by the processor, the generated Gen AI response based on a safety policy and computing a compliance score based on detection of disallowed content, personally identifiable information, and policy violations;
aggregating, by the processor, the accuracy score, the factual-consistency score, the at least one language quality score, the coverage score, and the temporal-consistency score into a validation score by applying a defined aggregation function, wherein the aggregation function comprises a weighted combination, a weighted average, and a learned scoring function, and wherein the learned scoring function being selected based on a query type, task requirements, and preconfigured importance values;
comparing, by the processor, the validation score with a predefined acceptance threshold to determine whether the generated Gen AI response satisfies quality requirements, wherein the predefined acceptance threshold being dynamically adjusted based on a historical performance, a query class, and an available token budget; and
performing, by the processor, at least one of selecting an alternative candidate response from previously generated candidate textual responses, generating follow-up prompts and re-invoking the Gen AI model using the follow-up prompts, and modifying the selected subset of nodes based on the comparison.

18. The method of claim 10, wherein fine-tuning the at least one Gen AI model and the ontological representation based on results of the validation comprises:
determining, by the processor, a requirement to perform fine-tuning of the at least one Gen AI model, and the ontological representation based on the results of validation and predefined fine-tuning triggers, wherein the predefined fine-tuning triggers comprise at least one of validation score below an acceptance threshold, systematic factual inconsistency rates above a factuality threshold, a recurring omission of ontological entities, a user feedback indicating unsatisfactory responses, and a scheduled periodic fine-tuning event;
determining, by the processor, a fine-tuning dataset comprising at least one of validated final responses, corresponding input prompts comprising the textual content and the generated ontological representation, negative examples, and provenance metadata linking each training dataset to the selected subset of nodes and cosine similarity scores;
preprocessing, by the processor, the fine-tuning dataset by performing at least one of a text normalization and tokenization, deduplication of redundant examples, anonymization and masking of personally identifiable information, a balancing of class or label distributions, and generation of input-output training pairs in a format required by selected fine-tuning procedure;
classifying, by the processor, the preprocessed fine-tuning dataset into training subsets, validation subsets and test subsets based on a configured split strategy;
selecting, by the processor, a fine-tuning strategy for the at least one Gen AI model from among an adapter-based fine-tuning, a low-rank adaptation (Lora), an instruction tuning, and a reinforcement learning;
configuring, by the processor, fine-tuning hyperparameters and training schedules based on the selected fine-tuning strategy, wherein the fine-tuning hyperparameters and training schedules comprise at least a learning rate, batch size, number of epochs, weight decay, gradient clipping, checkpoint frequency, early stopping criteria, and privacy constraints;
applying, by the processor, the selected fine-tuning strategy to the training subset, performing iterative optimization steps comprising forward passes, loss computation, backpropagation, parameter updates, periodic evaluation on the reserved validation subset, and checkpointing of intermediate model states;
identifying, by the processor, ontology update candidates comprising at least one of: missing entities, missing relations, incorrect entity types, incorrect temporal anchors, mislabeled priority weights, and recurring query-to-ontology alignment errors based on the fine-tuned Gen AI model and the fine-tuned ontological representation;
generating, by the processor, at least one modification to the ontological representation by at least one extracting candidate entity and relation modifications from validated final responses and from the contextual data, and deriving candidate structural changes to the ontological representation; and
modifying, by the processor, the ontological representation based on the generated at least one modification to generate updated ontological representation.

19. A non-transitory computer-readable medium comprising a processor-executable instructions that cause a processor to:
receive input prompt data corresponding to an enterprise from at least one data source, wherein the input prompt data comprises a user query and user requirements;
generate a query embedding vector representing the received input prompt data using an embedding model, wherein the query embedding vector comprises a numerical representation of the input prompt data indicating a semantic meaning corresponding to the input prompt data;
retrieve at least one relevant node corresponding to the input prompt data from a pre-determined ontological representation by calculating cosine similarities between the generated query embedding vector and a plurality of embedding vectors of a plurality of nodes within the pre-determined ontological representation using a collapsed tree retrieval model;
select a subset of nodes comprising the cosine similarities exceeding a predetermined retrieval threshold based on the retrieved at least one relevant node;
generate contextual data corresponding to the input prompt data by aggregating textual content from the selected subset of nodes;
generate an ontological representation corresponding to the input prompt data based on the generated contextual data, wherein the ontological representation comprises a plurality of nodes comprising the textual content and the embedding vectors derived using the embedding model;
generate a Generative Artificial Intelligence (Gen AI) response to the input prompt data using at least one Gen AI model based on the generated contextual data and the generated ontological representation;
validate the generated Gen AI response by comparing the Gen AI response with a reference response using at least one performance metric, wherein the at least one performance metric comprises at least one of accuracy-based measures, similarity-based measures, and quality assessment measures; and
fine-tune the at least one Gen AI model and the ontological representation based on results of the validation, wherein the fine-tuning of the ontological representation comprises updating a node content and the embedding vectors.

20. The non-transitory computer-readable medium of claim 19, wherein to generate the ontological representation corresponding to the input prompt data based on the generated contextual data, the processor-executable instructions cause the processor to:
initialize the ontological representation comprising the plurality of nodes, wherein each node comprises the textual content, an embedding vector, a parent pointer, a set of child nodes, a root node, and a depth value, wherein the root node being configured as a structural anchor;
identify a node position within the ontological representation for embedding an upcoming node by calculating the cosine similarities between the embedding vector of the upcoming node and the embedding vectors of the set of child nodes at each level;
embed the upcoming node as a leaf node at the identified node position based on a depth-adaptive similarity threshold and based on the calculated cosine similarities;
generate a corresponding child node for the embedded leaf node, wherein the corresponding child node comprises the textual content of the leaf node;
update textual content and embedding vectors of the generated corresponding child node along a traversal path using a conditional aggregation value and based on number of descendant nodes; and
generate an updated ontological representation corresponding to the input prompt data based on the updated textual content and updated embedding vectors.
